(19) United States
(12) Patent Application Publication
(10) Pub. No.: US 2013/0203574 A1
(43) Pub. Date: Aug. 8, 2013

(54) Lower Sealing and Cutting Device of Tubular Material Packaging

(71) Applicant: Weilong Cao, Shanghai (CN)

(72) Inventor: Weilong Cao, Shanghai (CN)

(21) Appl. No.: 13/824,948

(22) PCT Filed: Mar. 2, 2012
(86) PCT No.: PCT/CN12/71896

§ 371 Date: Mar. 18, 2013

(30) Foreign Application Priority Data
Aug. 26, 2011 (CN) 201110247902.1

(51) Int. Cl. B31B 19/14

(52) U.S. Cl. CPC B31B 19/14
USPC 493/17

(57) ABSTRACT

The present invention relates to a lower sealing and cutting device for tubular material packaging, and more particularly relates to a packaging device of pillow-type packaging. Compared with other pillow-type packaging methods for tubular material, the existing pillow-type packaging method for flaky materials has the disadvantages of wasting material which affects appearance, increased the price, adding additional working procedures, increased energy consumption, and high labor costs. The present invention is to provide a lower sealing and cutting device for tubular material packaging in which a new open-end is automatically formed and always kept in an opened state, while one by one a plurality of tubular materials form a packaging bag. According to the present invention, the open-end of the tubular material penetrates from the underside to the upside of the inner support pit, wherein the inner support with an upward top-end is within the tubular material. A sealing and cutting device is above the inner support seat, and an orifice fixing device is above the sealing and cutting device. A tube stretcher moves around up and down between the inner support pit and an orifice fixing member. An open-end fixing detector is connected with a fixture, and the tubular material packaging of the invention is used for pillow-type automatic packaging machines of tubular materials.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a pillow-type packaging machine, and more particularly to a packaging method for tubular material.

2. Description of Related Arts

Pillow-type packaging methods of the prior art are to seal both sides of a flat material along the longitudinal direction to form a cavity, and then put objects to be packaged into this cavity. The shape of a well packaged object looks like a pillow, and so named as a pillow-type packaging. The entire packaging process has a high degree of automation at a fast speed which is suitable for bulk, granular, powder, liquid objects, such as biscuits, pie, chocolate, bread, instant noodles, Chinese traditional food “moon cake”, soybean milk, milk, soybean sauce, cooking wine, or arrowroot flour. All these products can in turn be used for all kinds of daily necessities, industrial parts, medical devices and the like. A number of patents and conventional technologies associated with the pillow-type packaging machine have been disclosed.

It is expected that the pillow-type packaging method intends to seal a flaky material to form a cavity-like structure, all the while putting the objects to be packed into the cavity for packaging; however, this kind of packaging has the following disadvantages: 1. wasting materials such that the conventional pillow-type packaging machine is provided to package objects after sewing both sides of the flaky material, wherein the sewn part needs a considerable number of packaging materials; 2. influencing the appearance such that the seams remaining and stacked outside the packaging bags impact the appearance of the packaging bags; 3. the expensive cost such that in the forming process multilayer composite materials are required for making the packaging have a high cost; 4. adding extra procedures such that the processing steps for making a pillow-type flaky material packaging are increased, and thus the energy consumption and labor costs are increased as well relative to tubular material packaging.

Compared with the flaky material packaging process, the packaging process using a tubular material does not need multilayer composite materials, and does not generate an intermediate suture portion. Accordingly, the advantages of the packing process using a tubular material are a beautiful appearance, energy saving, and a lower cost.

Furthermore, there are considerable differences in the packing procedure if comparing tubular material packaging with flaky material packaging: 1. for the feeding process of a flaky packaging, the packaged object is involved with the flaky material therein so that it is not necessary to think of creating an open end, but for the feeding process of a tubular material packaging, since the root the of tubular material has one open end so that the packaged object has to be put into the tubular material from the open-end before the completion of the previous package, and the open end of the next package has to be formed and which has to be maintained in a opened state. Considering the flaky packaging material type, as long as just one piece is moving, the packaging speed is capable of being satisfied as requested, whereas a tubular material packaging type, needs that at least four packing material to be formed simultaneously so as to meet the requirements for packaging speed. This forms the problem of how to complete multiple packaging bags and form multiple open ends simultaneously.

Although a method using a pneumatic claw support is proposed in the Chinese patent application (CN200820162608) which disclosed “an orifice opening device of packing bag of automatic packaging machine for a disposable injector”, it forms the problem that there is no evidence to explain how to guarantee that a newly open-end cut is capable of opening.

Without appropriate technology it is impossible to form an automated production assembly-line, such that a manual operation process can be used for opening an open-end of tubular material. Accordingly, the working efficiency is poor, and it also impossible to meet the packaging requirements of items with a high hygiene requirement.

### SUMMARY OF THE PRESENT INVENTION

The present invention is to provide a new open-end for a lower sealing and cutting device of tubular packaging material which is automatically formed and always maintained in an opened state, while multiple tubular materials are being packaged in bags one by one.

The present invention is to provide a proposed solution to remedy the drawbacks of the aforementioned method, wherein an inner support with an upward top-end is placed into the open end of tubular material and clamped, wherein after the open-end is fixed at the orifice fixing device, the fixture loosens the inner support which slides downward within the tubular material so as to return into the inner support pit due to the gravity.

After the inner support is reverted into the inner support pit, part of the tubular material above inner support is sealed laterally and cut using a sealing and cutting device, wherein all the upper cutting places of the tubular materials are the packaging bags, whereas the lower cutting place of which each one is a new open-end. Because there is an inner support with upward top-end within each of the new open-end, all the open-ends have to be above the top-end of the inner support so as to make each of the open-ends always be maintained in an opened state.

The present invention is implemented by providing a lower sealing and cutting device for the tubular material packaging which comprises an inner support, a tube stretcher, an inner support seat, an orifice fixing device, a sealing and cutting device, an open end fixing detector, a height detector, and a tubular material;

Wherein a number of the inner support pits are configured on the inner support, wherein the tube stretcher has a fixture capable of clamping or loosening all of the inner supports, wherein the fixture moves to the orifice fixing device along a guide rail, wherein a number of the orifice fixing member are configured on the orifice fixing device, wherein closing the orifice fixing member fixes the open-end of the tubular material, wherein after the open-end is fixed at the orifice fixing member, the orifice fixing detector send out the fixed orifice information, wherein after the fixture reaches a predetermined height, the height detector sends out the height information, wherein the sealing and cutting device is in a normally in a opened state, but shifts to a closed state to laterally seal and cut the tubular material, wherein all of the inner support pits are arranged into a column, wherein the open-end of the tubular material is above the inner support pit, wherein the inner support is within the tubular material, wherein the lower part is inside the inner support pit, wherein the sealing and cutting device is above the inner support seat, wherein the orifice fixing device is above sealing and cutting device, wherein the fixture of the tube stretcher moves around up and down between the inner support pit and the orifice fixing member, wherein the inner support pit is in the middle of the fixture which is in a opened state, wherein the amount and position of the orifice fixing member are the same as the amount and position of the inner support pit, wherein the open-end fixing detector is connected with the fixture, wherein the height detector is connected with the orifice fixing member.

According to another feature of the invention, after the height detector sends out the height information, the orifice fixing member is closed.

According to a further feature of the invention, after open end fixing detector sends out the orifice-fixed information, the fixture is loosed.

According to still yet another feature of the invention, the transverse cross-sectional area of the inner support is less than the inner diameter of the tubular material.

According to a still yet another feature of the invention, the longitudinal cross-sectional area of the inner support is greater than the inner diameter of the opened tubular material.

According to a still another feature of the invention, the weight of the inner support is less than five grams.

Accordingly, the advantages obtained by the invention are such that an inner support slides downward, due to gravity, and is to open the tubular material; wherein the tubular material is cut at a position where it is over the top-end of the clamped inner support and a new open-end is formed. The method according to the present invention is simple, reliable, the equipment is not complicated, and the cost is lowered.

### BRIEF DESCRIPTION OF THE DRAWINGS

### Description of the Drawings

FIG. 1 is a schematic side view of the initial state of the present embodiment.

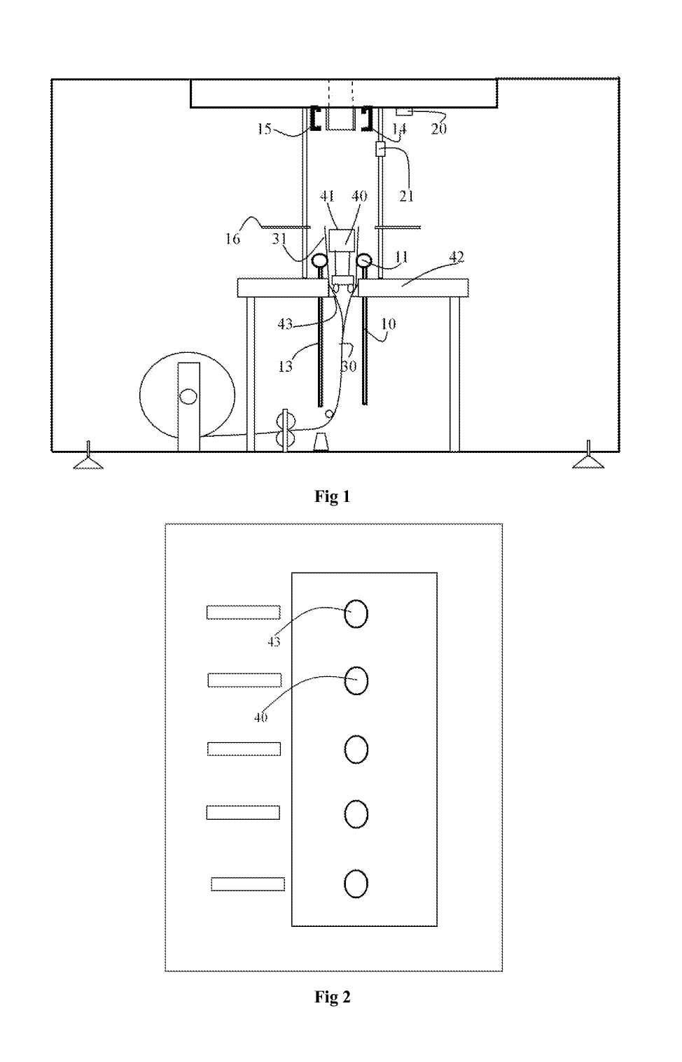

FIG. 2 is a schematic sectional view of the initial state of the present embodiment.

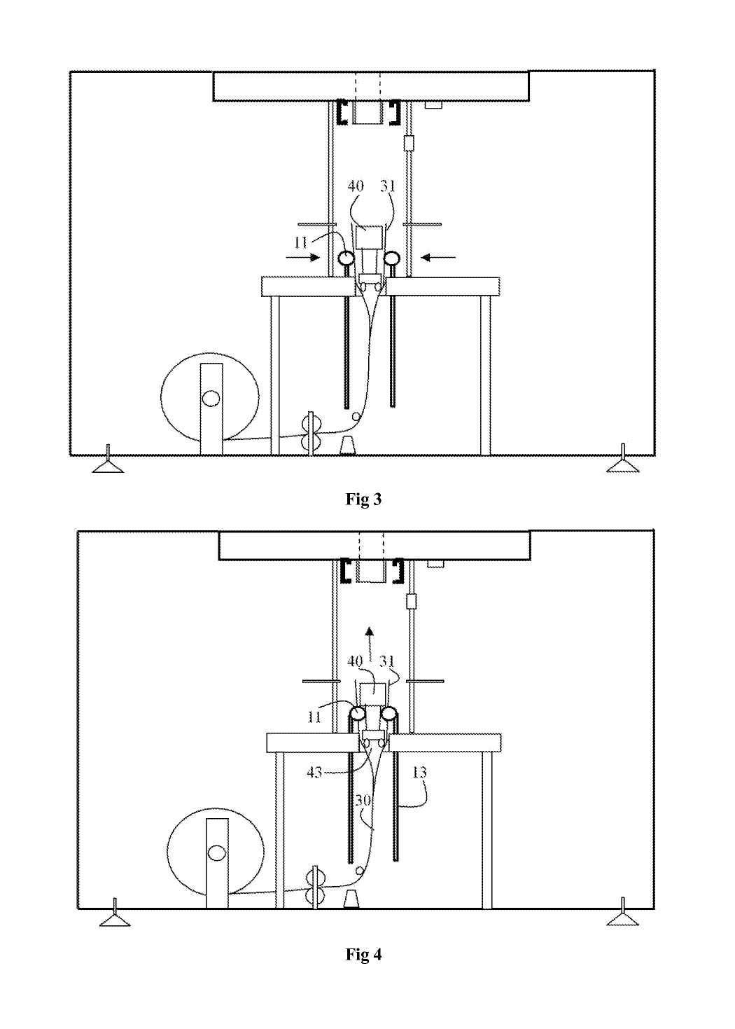

FIGS. 3˜10 are a schematic side views of the operating state of the present embodiment.

The drawing symbols are described as follows: 10: tube stretcher; 11: fixture; 13: guide rail; 14: orifice fixing device; 15: orifice fixing member; 20: open end fixing detector; 21: height detector; 30: tubular material; 31: open end; 32: packaging bag; 40: inner support; 42: inner support seat; 43: inner support pit.

There are five discharge orifices and five holding members that forming five unloading units. The number of unloading units according to the present invention is not limited to five, unloading units be greater or less than five.

The operation of each member in the present embodiment can be completed by selecting electric or pneumatic means, but for the purpose of simple illustration, the power supply and the motive power will not be described hereinafter and in the drawings.

### DETAILED DESCRIPTION OF THE PREFERRED EMBODIMENT

FIG. 1 is a schematic side view of the initial state of an example. In respect to side view, only a state pattern is shown in the figure. As illustrated, an inner support pit 43 is above an inner support seat 42, wherein an inner support 40 is inside a tubular material 30, the lower part of an inner support 40 is inside an inner support pit 43. An open-end 31 of the tubular material 30 is above the inner support pit 43. The transverse cross-sectional area of the inner support 40 is less than inner diameter of said tubular material 30, and the longitudinal cross-sectional area of the inner support 40 is greater than inner diameter of the opened tubular material 30.

Fixture 11 situated on the two sides of the inner support 40 when the inner support 40 is in a loosened state. If the fixture 11 is closed it can hold all of the inner support 40 simultaneously. A sealing and cutting device 16, capable of opening and closing, is above the inner support seat 42 which is closed or opened in a horizontal direction. In the figure, the sealing and cutting device 16 is currently in a opened state, and the sealing and cutting device 16 is capable of laterally sealing and cutting the tubular material 30.

An orifice fixing device 14 is above the sealing and cutting device 16. The sealing and cutting device contains has five orifice fixing members 15. The number and position of the orifice fixing member 15 are the same as the number and position of inner support pit 43. When closed, the orifice fixing member 15 are capable of fixing an open-end 31 on the tubular material 30. After an open-end 31 is fixed at orifice fixing member 15, an open-end fixing detector 20 sends an orifice-fixed information. The open-end fixing detector 20 is connected with a fixture 11. After the open-end 31 sends out the orifice-fixed information, the fixture 11 is loosened accordingly.

The fixture 11 of the tube stretcher 10 move up and down between the inner support pit 43 and the orifice fixing member 15 along the guide rail 13. The inner support pit 43 is in the middle of the fixture 11 which is in an opened state. The fixture 11 is capable of moving to the orifice fixing device 14 along the guide rail. After the fixture 11 reaches a predetermined height, the height detector 21 sends out the height information. The height detector 21 is connected to the orifice-fixing member 15. After height detector 21 sends out the height information, orifice fixing member is closed.

FIG. 2 is a schematic sectional view of the initial state of the present embodiment. As illustrated, five of inner support pits 43 and inner supports 40 are arranged side by side. All of said inner support pits 43 are arranged into a column forming five packaging units. The number of packaging unit of present invention is not limited to five, but can be greater or less than five in other embodiments.

FIG. 3 is a schematic side view of the first operating step where the fixture 11 starts to close and gets into position to clamp the open end 31. Fixture 11 is inwardly closed along the direction indicated by the arrows to clamp all of the inner supports 40 within the open end 31. Since the open-end 31 is between the fixture 11 and the inner support 40, this means that if the fixture 11 clamped the inner support 40 the open-end 31 is clamped as well.

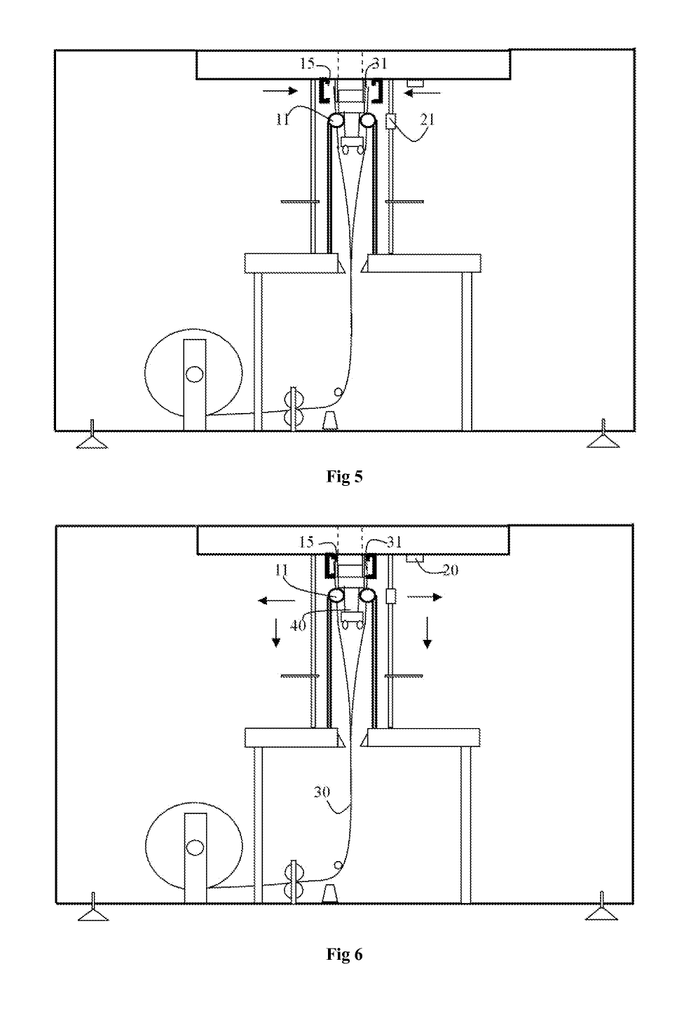

FIG. 4 is a schematic side view of the second operating step where the fixture 11 starts to move upward along the guide rail. After fixture 11 is inwardly closed, the fixture 11 clamps all of the inner supports 40 on the inner support pits 43 and begins to move upward. Because the open-end 31 moves upward, the tubular material 30 also moves upward simultaneously.

FIG. 5 is a schematic side view of the third operating step where fixture 11 moves to the orifice fixing member 15 which fixes the open-end 31. After fixture 11 moves to orifice fixing device 15, which has reached a predetermined height, the height detector 21 sends out the height information. The height detector 21 is connected with the orifice fixing member 15. After the height detector 21 sent out the height information, the orifice fixing member 15 begin to close and clamp the open-end 31. After the orifice fixing member 15 clamps the open-end 31, which is fixed at the orifice fixing member 15, the open-end fixing detector 20 sends out the orifice fixed information. The open-end fixing detector 20 is connected with fixture 11. After the open-end 31 sends out the orifice fixed information, the fixture 11 is loosened accordingly. When clamp 11 is loosened, the inner support 40 begins falling downward due to its own weight. Because each one of the open-end 31 is fixed to the orifice fixing member 15, the tubular material 30 does not move and the inner support 40 is capable of only dropping within the tubular material 30 downward onto the inner support pit 43. The opened fixture 11 begin to move downward outside the tubular material 30 while the fixture 11 is loosened.

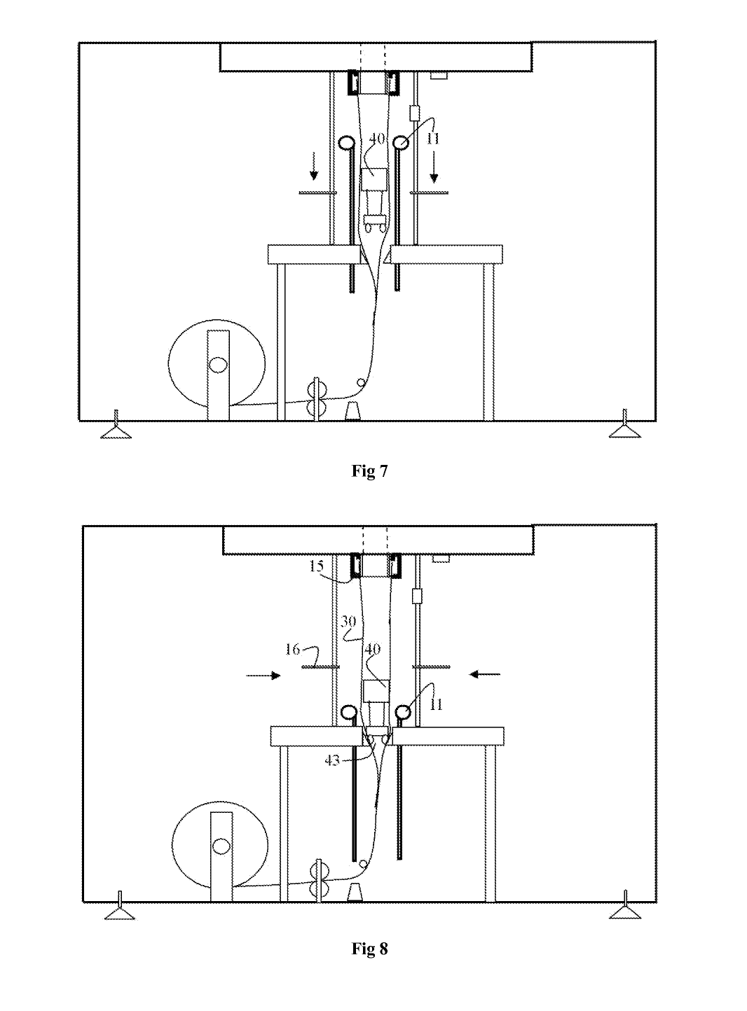

FIG. 7 is a schematic diagram of the fixture 11 and the inner support 40 moving downward.

FIG. 8 is a schematic side view of the fifth operating step where the sealing and cutting device 16 begins to close. At this moment, all of the tubular materials 30 are fixed onto the orifice fixing member 15. All of the orifice members 15 are arranged in a column, and all of the tubular materials 30 are also arranged in a column. The sealing and cutting device 16 is in an opened state on the two sides of the tubular materials 30 arranged in a column. After all of the inner supports 40 and fixture 11 have returned to the original position, the sealing and cutting device 16 begins to close.

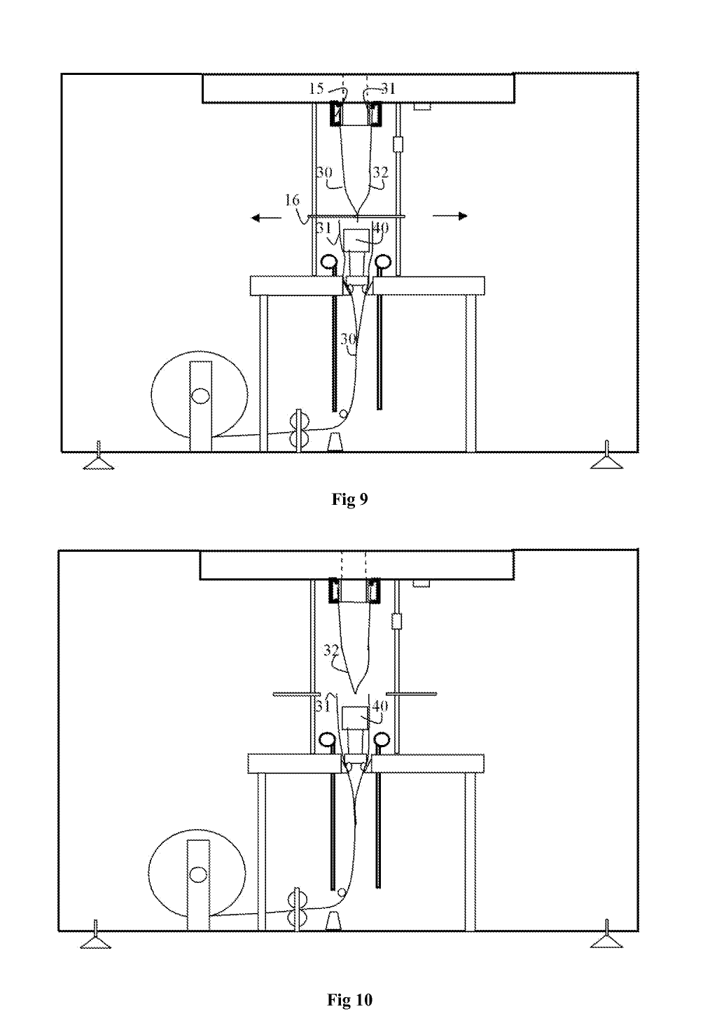

FIG. 9 is a schematic side view of the sixth operating step of the sealing and cutting tubular material 30. The closure of the sealing and cutting device 16 is in the horizontal direction. The closed sealing and cutting device 16 laterally seals and cuts the tubular material 30. After it is closed, the sealing and cutting device 16 is opened again immediately. After sealing and cutting, the cut and sealed tubular material 30 became as follows:

The part of tubular material 30 above the sealing and cutting device 16 becomes an open-end 31 hanging on the sealed packaging bag 32 which is situated on the bottom of the orifice fixing member 15.

The top-end of tubular material 30 under the sealing and cutting device 16 become a new open-end 31, and the inner support 40 is within the new open-end 31.

FIG. 10 is a schematic side view of the seventh operating step where packaging bag and a new open-end have been formed after sealing and cutting.

What is claimed is:

1. A lower sealing and cutting device for tubular packaging material, comprising: an inner support (40), a tube stretcher (10), an inner support seat (42), an orifice fixing device (14), a sealing and cutting device (16), an open-end fixing detector (20), a height detector (21), and a tubular material (30), wherein a number of inner support pits (43) are configured on said inner support seat (42), wherein said tube stretcher has a fixture (11) for clamping or loosening all of said inner supports (40), wherein said fixture (11) moves to said orifice fixing device (14) along a guide rail, wherein a number of orifice fixing members (15) are configured on said orifice fixing device (14), wherein orifice fixing member (15) are closed to fix the open-end (31) of said tubular material (30), wherein after an open-end (31) is fixed at said orifice fixing member (15), said orifice fixing detector (20) sends out an orifice fixing information, wherein after said fixture (11) reaches a predetermined height, said height detector (21) sends out the height information, wherein said sealing and cutting device (16) is normally in an opened state, but can switch to a closed state to laterally seal and cut said tubular material (30), wherein all of said inner support pits (43) are arranged into a column, wherein said open end (31) of said tubular material (30) is above said inner support pit (43), wherein said inner support (40) is within said tubular material (30), wherein the lower part of said inner support (40) is inside said inner support pit (43), wherein said sealing and cutting device (16) is above said inner support seat (42), wherein said orifice fixing device (14) is above said sealing and cutting device (16), wherein said fixture (11) of said tube stretcher (10) moves up and down between said inner support pit (43) and orifice fixing member (15), wherein said sealing and cutting device (16) is opened or closed in a horizontal direction, wherein said inner support (40) is in the middle of said sealing and cutting device (16) which is in a opened state, wherein the amount and position of said orifice fixing member (15) is the same as the amount and position of said inner support pit (43), wherein said open-end fixing detector (20) is connected with said fixture (11), and said height detector (21) is connected with said orifice fixing member (15).

2. A lower sealing and cutting device for tubular material packaging, according to claim 1, wherein after said height detector (21) sends out said height information, said orifice fixing member (15) is closes.

3. A lower sealing and cutting device for tubular material packaging, according to claim 1, wherein after said open-end fixing detector (20) sends out said orifice fixed information, said fixture (11) is loosened.

4. A lower sealing and cutting device for tubular material packaging, according to claim 1, wherein the transverse cross-sectional area of said inner support (40) is less than the inner diameter of said opened tubular material (30).

5. A lower sealing and cutting device for tubular material packaging, according to claim 1, wherein the longitudinal cross-sectional area of said inner support (40) is greater than inner diameter of said opened tubular material (30).

6. A lower sealing and cutting device for tubular material packaging, according to claim 1, wherein the weight of said inner support (40) is less than five grams.
